(19) United States
(12) Patent Application Publication
(10) Pub. No.: US 2008/0288530 A1
(43) Pub. Date: Nov. 20, 2008

(54) User-Defined Fields with Automatic Numbering

(75) Inventors: Ran J. Flam, Pout Monmouth, NJ (US); Daniel Kogan, Manalapan, NJ (US)

Correspondence Address: GORDON E NELSON;PATENT ATTORNEY, PC, 57 CENTRAL ST, PO BOX 782, ROWLEY, MA, 01969, US

(73) Assignee: Sparta Systems, Inc.

(21) Appl. No.: 12/015,854

(22) Filed: Jan. 17, 2008

Related U.S. Application Data
(60) Provisional application No. 60/885,223, filed on Jan. 17, 2007.

(51) Int. Cl. G06F 17/00

(52) U.S. Cl. 707/102; 707/E17.001

(57) ABSTRACT

A process control system that automatically monitors processes and performs activities based on conditions detected during monitoring. The system includes: a server that has access to a database system and executes program code of the process control system; a table of process records in the database system, a process record indicating a current condition of a process being controlled by the system and certain ones of the process records including one or more auto numbering user-defined fields; and a portion of the program code which is executed when a process record enters a pre-defined state, whereby an auto numbering field value is generated according to a configuration of the auto numbering user-defined field and storing the generated auto number field value in the auto numbering user-defined field in the process record. The auto numbering user-defined fields and their configuration are indicated in other tables in the database system.

### CROSS-REFERENCE TO RELATED APPLICATIONS

This application claims priority to co-pending U.S. provisional patent application entitled “User-Defined Fields with Automatic Numbering”, Ser. No. 60/885,223, filed on Jan. 17, 2007.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

This invention relates to the field of process control, and more particularly to techniques for implementing user-defined fields with automatic numbering in a table-driven process control system.

2. Description of Related Art

To date, the use of computers in process control systems has typically been limited to employing a calendar-date system that reminds the operator when an activity is due to be performed. Conventionally, process control systems suffer from a major drawback. Typically, they rely on a singular input, such as calendar date and time, and require human interaction to respond to such events and their recurrence and to make decisions and take action accordingly; an example of such a system is Outlook™, manufactured by Microsoft Corporation™, with its reminder capability.

Although computer programs can always be developed to implement responses to specific conditions arising during a process and to particular sequences of conditions, such programs are of limited use, as they require code changes whenever new conditions and new requirements arise. Moreover, when the tracking of the process is required or desired through the use of a unique identifier, such identifier requires manual generation, is generated using application specific code, or uses system information which has limited meaning to the user.

Accordingly, there exists a need for a process control system that eliminate the dependency on human operators and that provides an automatic numbering feature in the tracking of a process.

### BRIEF SUMMARY OF THE INVENTION

A process control system includes: a server that has access to a database system and executes program code for the process control system; a table of process records in the database system, a process record indicating a current condition of a process being controlled by the system and certain ones of the process records including one or more auto numbering user-defined fields; and a portion of the program code which is executed when a process record enters a pre-defined state, whereby an auto numbering field value is generated according to a configuration of the auto numbering user-defined field and storing the generated auto number field value in the auto numbering user-defined field in the process record.

In one aspect, the system implements the auto numbering user-defined fields using a table of auto numbering user-defined fields in the database system, comprising a record for each of the auto numbering user-defined fields, and a table of auto numbering process record status in the database system, comprising a record for each pre-defined process record state in which each auto numbering user-defined fields is to be generated.

In one aspect, the auto numbering user-defined fields are associated with classes, which are then associated with a record type of the process record.

In one aspect, the configuration of the auto numbering user-defined fields is set forth in a table of auto numbering components, comprising a record for each component to be used for generating or updating the auto numbering user-defined field. The columns in each record of the auto numbering components table comprises settings for: a source field; a date format; a prefix or suffix; a counter; and how characters from the source field will be used in a concatenation of results from each source field for the auto numbering user-defined field.

In one aspect, configuration for a component of the auto numbering user-defined field is set forth in a table of auto numbering word tokens, comprising a record for each separator to be used for tokenizing an alpha numeric source field, and a table of auto numbering component words for specifying what to do with words taken from a source field to build a component, comprising a record for each specification for a component.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1 shows an overview of an embodiment of automated process control system 801 that is constructed according to the principles of the invention.

FIGS. 2 and 3 are entity-relationship diagrams which show relationships between the database tables of system.

FIG. 4 illustrates the database tables that implement the auto number user-defined fields in the system.

FIG. 5 is an entity-relationship diagram which shows relationships between the database tables of system which implement the auto numbering user-defined fields.

FIG. 6 is a flowchart illustrating the generation of auto numbers by the system.

FIG. 7A-15 show GUI's for configuring auto numbering user-defined fields.

### DETAILED DESCRIPTION OF THE INVENTION

The following Detailed Description will begin with an overview of a process control system in which the invention is embodied, continue with a detailed description of some of the tables belonging to the process control system and the relationships between them, and finally describe the techniques for setting user-defined fields with automatic numbering of the process record.

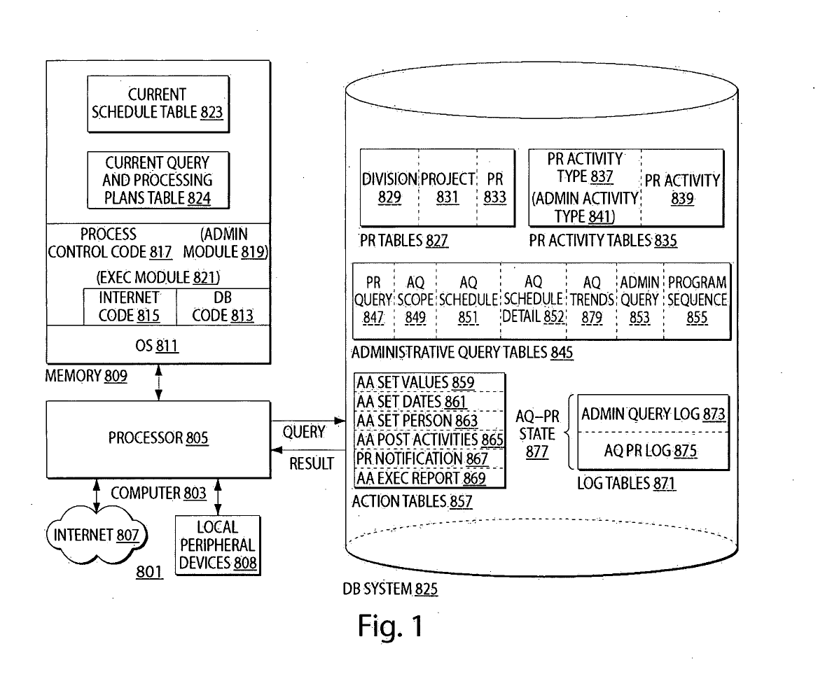

Overview of the Process Control System in which the Invention is Embodied—FIG. 1

FIG. 1 shows an overview of an embodiment of automated process control system 801 that is constructed according to the principles of the invention. The embodiment is used to control business processes such as handling orders or customer complaints, but the techniques of the invention can be employed equally well in systems that control industrial or technical processes such as oil refining, electric power generation, or telephone or packet switching.

System 801 is implemented using a standard computer 803 that is connected to a standard database system 825. In a preferred embodiment, the database system is a relational database system made by Oracle Corporation, of Redwood City, Calif. Standard computer 803 has a processor 805 which is connected to Internet 807 and to local peripheral devices 808 as well as to database system 825. Processor 805 has a memory 809 (understood to include both physical and virtual memory) which includes code executed by processor 809. Of interest to the present discussion is standard operating system code 811, Internet code 815, for performing functions such as email and interacting with Web pages according to the HTTP protocol, Database code 813, which is part of and controls the operation of database system 825, and process control code 817, which is application code that implements the process control system. Process control code 817 uses components of the operating system 811, Internet code 815, and DB code 813 to interact with Internet 807, local peripheral devices 808, and DB system 825. With regard to the interaction with DB system 825, process control code 817 issues queries to DB system 825 and receives the results of the queries from DB system 825.

In broad terms, process control system 801 works by making records of processes that are being controlled in a table in database system 825 and using predefined queries that are stored in a table database system 825 to repeatedly query the table and perform activities that are predefined for the query on the result set of records returned by the query. The repeated queries are executed automatically by system 801. The predefined and automatically executed queries are termed herein administrative queries. An activity is made up of a number of predefined actions, and when the activity is performed, system 801 executes its actions. The activities to be performed by an administrative query, as well as an activity's actions, are also defined by entries in tables in the database system, and log tables in the database system determine the state of a process record returned by the administrative query with regard to that execution of the administrative query. When an execution of a query returns a process record, system 801 uses the state information to determine what activity is to be performed with regard to the process record.

Current schedule table 823 in memory 809 contains an entry for each administrative query which system 801 is repeatedly executing; the entry for the query in table 823 includes the time for the next execution of the query by system 801. Current query and processing plans table 824 is an optimization; when system 801 begins execution of an administrative query, it reads the information needed to execute the administrative query and perform any activities associated with it from the records in database system 825 that define the query and the activities and stores the information in table 824, where it is quickly and easily available to system 801 for use during the execution of the administrative query. Tables 823 and 824 are updated whenever system 801 checks database system 825 and finds that configuration tables have changed; such update of table 823 and 824 is then performed based on the configuration information fetched from database system 825.

As would be expected from the above overview, database system 825 includes PR tables 827, which are the tables that contain the records for the processes, PR activity tables 835, containing records that define and log the activities, action tables 857, whose records define the actions that make up an activity, and administrative query tables 845, which define the administrative queries that system 801 may execute on the PR tables 827. The definition of an administrative query includes the query, one or more activities to be performed, and the intervals at which the administrative query is to be made. Log tables 871 keep track of the state of a process with regard to a query and also chart trends in the processes being controlled. Log tables 871 and program sequence 855 together permit the activity that is performed when a query finds a PR record to be selected according to the state of the PR record with regard to the current execution of the administrative query.

To give a concrete example, one type of process that can be controlled by system 801 is a customer complaint. The exemplary process for dealing with a customer complaint is to assign it to a customer complaint specialist. The customer complaint specialist is to investigate the complaint and reply to the customer within a set time period. If the reply is not timely, the complaint is escalated to the customer complaint specialist's supervisor, again with a time limit for the supervisor to deal with the problem. The activity that corresponds to the escalation is the dispatch of an email message to the supervisor. In system 801, when the complaint arrives, a PR record for the complaint is made in a table in PR tables 827. When the complaint specialist replies to the customer, the PR record is altered to indicate that the complaint specialist has replied and the time of the reply. System 801 periodically runs a query contained in administrative query tables 845 which queries PR table 833 for PR records that indicate that the complaint specialist has not timely replied. The query further specifies that when the complaint specialist has not timely replied, the activity to be performed is to escalate the complaint by sending email to the supervisor. When system 801 finds such a record, it performs the specified activity, as defined by records in PR activity tables 835 and in action tables 857. System 801 records the time at which the query was run, the fact that the PR record was found and the activity performed in log tables 871. As will be explained in detail later, one function of log tables 871 is to record the state of a process with regard to a given PR record and a given execution of a query and to permit different executions of the given query to result in different activities being performed for the given PR record, depending on the state of the process. For instance, once the escalation is recorded in the log tables with regard to the query and the PR record, further executions of the query will not result in repeated escalation activities. In the terminology that is used in the following, once the query has resulted in the performance of the escalation activity for the given PR record, the given PR record is in a state of Persistent Conditions with regard to the query and because the given PR record is in the state of Persistent Conditions, the escalation activity is not repeated.

The use of tables in DB system 825 to determine the behavior of the process control system makes system 801 highly configurable, but limits the configurability so that it can be safely done by non-technical users of system 801. All of the tools provided by DB system 825 for configuring entries in its tables are available to configure the entries in the tables of system 825, as are the user interfaces which DB system 825 provides for those tools. These user interfaces strongly limit the amount of damage that can be done to the tables, and thereby to system 801, by an unskilled user. For example, only a system manager may be permitted to define tables or add tables to or delete them from the database; a less skilled user may be permitted only to add or delete records in existing tables, and a completely unskilled user may be permitted only to modify fields in existing records. System 801 is made still more safe and easy to use by a graphical user interface that is implemented on top of the user interfaces provided by DB system 825. Using the graphical user interface, the user of the system can define PR records as required for the occurrences that are important to his or her processes, can define his or her own PR activities in PR activity tables 835, can define his or her own queries in administrative query tables 845, including the activities to be performed in response to the queries, and can define an activity's actions in detail in action tables 857. What can be done by a given action is limited by the form of its record in the action table to which it belongs, and this, too, greatly contributes to the safety with which system administrative queries can be configured. In defining the activities to be performed, the user can further define states for the process represented by the record and the activities to be performed in the various states. Both configuration and query execution are done by process control code 817, which accordingly includes an execution module 821, which executes queries and schedules next executions in current schedule table 823 and an admin module 819, which adds records to and deletes them from the tables and configures the individual records. System 801 can run on a single computer 803, which functions as a server for the system, or alternatively it can run concurrently on a plurality of servers for load balancing purposes.

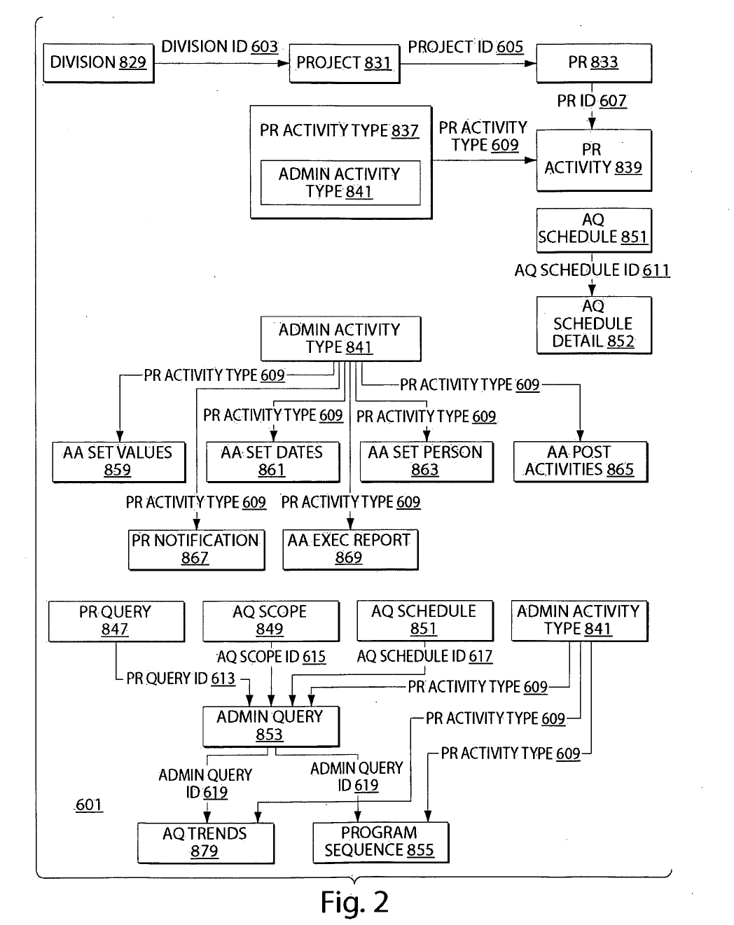

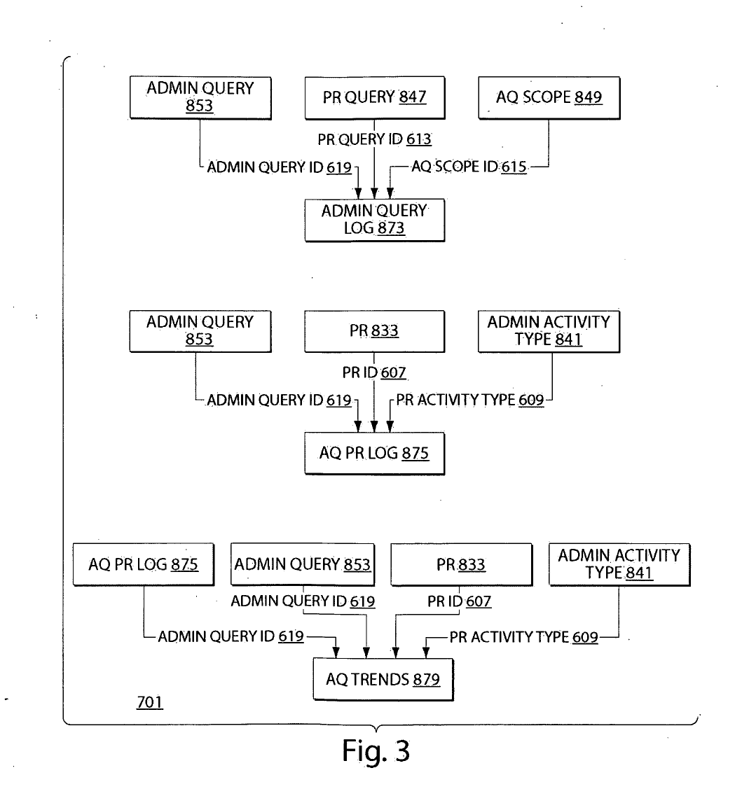

Relationships Between the Tables in DB System 825: FIGS. 2 and 3

FIGS. 2 and 3 are entity-relationship diagrams which show relationships between the database tables of system 801 which are important in the present context. In relational database systems generally, tables are related to each other by values in the tables records. For example, each record in a first table may have a record identifier field that contains a unique identifier for the record. Each record in a second table may have a record reference field that contains a value which is one of the unique identifiers for the records in the first table. The unique identifier for a given record in the first table may be used in a query to locate records in the second table whose record reference field contains the given record. Similarly, the value of the record reference field may be used in a query to locate the record in the first table whose record identifier field has the value contained in the record reference field in the second table's record. It should be noted here that the relationships between records in tables may be one-to-many, as in the case of the relationship between a given record in the first table and the records in the second table whose record reference field contains the given record's unique identifier, or one-to-one, as is the relationship established by the unique identifier value between a given record in the second table and a record in the first table.

In FIGS. 2 and 3, boxes representing the tables of FIG. 1 are connected by arrows that are labeled with the name of a field whose value is a unique identifier for a record in the table which is the source of the arrow. Values from that field also appear in the records of the table which is the destination of the arrow and relate those records to the record whose unique identifier they contain. The relationship between a record in the table which is the source of the arrow and records in the table which is the destination is generally one-to-many, but is in some cases one-to-one.

These relationships between records in the tables are used to organize the data in the database. For example, in system 801, the records representing processes that are being controlled by system 801 are in PR table 833, which contains one record per process being controlled. In system 801, the user can group the records in PR 833 by project, and can group projects by division. The subdivision is done by means of Project table 831 and Division table 829. Each record in PR table 833 has a field, project_id, whose value is an identifier for a record in Project table 831, and that record identifies the project that the record in PR table 833 belongs to. Each record in Project table 831 has a field, division_id 603, whose value identifies a record in Division table 829, and that record identifies the division that the record in Project table 831 belongs to. A query on PR table 833 by a given value of project_id 605 will return all of the records in PR table 833 for processes that belong to that project. Project table 831 and Division table 829 are related in the same way by division_id 603.

A set of relationships that is particularly important for the present discussion is the set of relationships between the tables PR 833, PR_activity 839, PR_activity_type 837, Admin_activity_type 841, Action tables 857, Admin_query 853, and Program_sequence 855. All of these tables have to do with the performance of activities for processes. There are two broad classes of activities—ones done by human users of system 801 and ones done by system 801 itself in connection with executions of administrative queries on PR table 833 that return non-empty result sets. The latter activities are termed administrative activities. The administrative activities are performed with reference to the PR records of the result sets.

An important feature of system 801 is that a user can define his or her own activities. The mechanism for doing this is PR_activity_type table 837, whose records represent descriptions of activities. Each such description is termed herein a PR activity type. Fields in other tables of FIGS. 2 and 3 whose values are identifiers for PR_activity_type records have the name pr_activity_type, which appears at 609 in FIGS. 2 and 3. The PR_activity_type records that represent descriptions of administrative activities form a logical subtable of PR_activity_type table 837. This subtable appears as Admin_activity_type table 841 in FIG. 1. In the following, the descriptions in subtable 841 are termed herein Admin activity types.

An Admin activity type is effectively a kind of program for the administrative activity. When system 801 performs an administrative activity, it executes the Admin activity type for the administrative activity with regard to a specific PR record returned by an execution of an administrative query. One can thus speak of an execution of an Admin activity type with regard to a given PR record. As is generally the case with programs, the specific activity resulting from a given execution of an Admin activity type may depend not only on the Admin activity type, but also on values contained in the PR record with regard to which the Admin activity type is being executed. Which Admin activity type is selected for execution may further depend on the state of the given PR record with regard to the execution of the administrative query.

When system 801 executes an Admin activity type, it performs one or more actions. Each of the actions is described in a record in action tables 857. Each record in action tables 857 is related to a specific Admin activity type by a field in the action table record whose value is the identifier for the Admin activity type's record in PR_activity_type table 841, as seen in FIG. 2. There can thus be many records in action tables 815 related to a given Administrative activity type. When the Administrative activity type is executed, all of the action table records related to the Administrative activity type are executed. The result of the execution of a given action table record may depend on values in the PR record with regard to which the Admin activity type is being executed.

PR_activity table 839, finally, is a table whose records represent activities that have been performed or are scheduled to be performed with regard to a given PR record. Thus, as shown in FIG. 2, each PR_activity record includes a unique identifier (pr_id 607) for a record in PR 833 and a unique identifier (pr_activity_type 609) for the record in PR_activity_type table 837 that represents the PR activity type for the activity represented by the record. In the case of administrative activities, the record in PR_activity table 839 represents the activity which system 801 performs when it executes the Admin activity type specified by pr_activity_type 609 on the PR record specified by pr_id 607.

As shown in FIG. 2, each record representing an administrative query in Admin_query table 853 includes a unique identifier for a record in PR_activity_type table 837. The record is the Admin activity type which system 801 executes the first time the administrative query returns a given PR record to perform the initial administrative activity. It has already been indicated that when consecutive executions of the administrative query return the given PR record, the given PR record is in a state of Persistent Conditions with regard to the administrative query and on subsequent executions of the administrative query, system 801 may perform administrative activities other than the initial administrative activity with regard to the PR record. Administrative activity types for these other administrative activities are specified in records in Program_sequence table 855 that are associated with the administrative query, and accordingly, each of these records includes a unique identifier for a record in PR_activity type table 853.

Details of Certain Tables in DB System 825

PR Table 833

A record in PR table 833 looks like this:

| | |
|---|---|
| PR ( | |
| id | NUMBER (12) NOT NULL, |
| project_id | NUMBER (12), |
| ref_number | VARCHAR2 (40), |
| name | VARCHAR2 (80), |
| parent_id | NUMBER (12), |
| status_type | NUMBER (6), |
| category_type | NUMBER (6), |
| reason_opened_type | NUMBER (6), |
| priority_type | NUMBER (6), |
| severity_type | NUMBER (6), |
| exposure_type | NUMBER (6), |
| entity_id | NUMBER (12), |
| customer_rel_id | NUMBER (12), |
| originator_rel_id | NUMBER (12), |
| responsible_rel_id | NUMBER (12), |
| required_time | NUMBER (10, 2), |
| required_cost | NUMBER (12, 2), |
| date_opened | DATE, |
| date_due | DATE, |
| date_closed | DATE, |
| date_last_activity | DATE, |
| date_current_state | DATE, |
| is_closed | NUMBER (1), |
| date_created | DATE NOT NULL, |
| date_updated | DATE NOT NULL, |
| created_by_rel_id | NUMBER (12), |
| updated_by_rel_id | NUMBER (12), |
| primary key(id) | |
| ) | |

PR table 833 contains all process records (PR records) in the database. The data fields in this table describe a process and contain such information as priority, customer and date due. A first group of the fields must appear in every PR record; other fields may be added as required by the application. The other fields in the present example offer a typical example of how a PR record may be configured.

Essential Fields

The essential fields of a PR record are: (a) id: a unique ID for the record in this table, referred to in FIGS. 2 and 3 as pr_id 607, (b) project_id: the ID of the record in Project table 833 for the project that the project represented by the given PR record belongs to, (c) date_created: the exact date/time that a given PR is created, i.e., that the given row into the PR has been inserted, (d) date opened: the date/time that the associated process, event, etc. should be associated with, e.g., the date/time that a customer called with a request, (e) parent_id: the ID of a parent PR, if any, (f) status_type: current status of the PR, e.g., “Opened”, and “Work in Progress”, (g) is closed: a Boolean value indicating whether a PR is closed or is still active, (h) date_due: the date due for completing a process, i.e., date due for closing a PR, (i) created_by_rel_id: a specific ID of a person who created the given PR record in the database, (j) originator_rel_id: a specific ID of a person who is considered the originator or the “sponsor” of the given PR, (k) responsible_rel_id: a person that is assigned to the given PR, referred to as the Assigned To, (l) updated_by_rel_id: a specific ID of a person that the given PR was last updated by, (m) date_current_state: a date/time that the status of the given PR was last changed, (n) date_closed: a date/time that the given PR was closed, if at all, (o) date_last_activity: a date/time that a PR Activity was last performed for the given PR, (p) customer_rel_id: a specific ID of a contact associated with the given PR, (q) entity_id: a specific ID of a company associated with the given PR, and (r) date_updated: a date and time that a given record in the PR table was last updated.

Fields Defined for a Particular Application

The following additional PR data fields are examples of additional fields that can be defined as needed): (s) category type: a value from a “Category” pick-list, with possible selections such as: “Hardware”, “Software”, and “Documentation”, (t) reason_opened_type: a value from a “Reason Opened” pick-list, with possible selections such as: “Service Request”, “Problem Report”, and “Request for Information”, (u) priority_type: a value from a “Priority” pick-list, with possible selections such as: “Low”, “Medium”, and “High”, (v) severity_type: a value from a “Severity” pick-list, with possible selections such as: “Low”, “Medium”, and “High”, (w) exposure_type: a value from an “Exposure” pick-list, with possible selections such as: “Limited”, “All Customers”, and “All Customers and Employees”, (x) required time: estimated time to complete the given PR, (y) required_cost: estimated time to complete the given PR.

Project Table 831

A record in Project table 831 looks like this:

| | |
|---|---|
| Project ( | |
| id | NUMBER (12) NOT NULL, |
| name | VARCHAR2 (80) NOT NULL, |
| division_id | NUMBER (6) NOT NULL, |
| project_type | NUMBER (6) NOT NULL, |
| created_by_rel_id | NUMBER (12) NOT NULL, |
| updated_by_rel_id | NUMBER (12) NOT NULL, |
| date_created | DATE NOT NULL, |
| date_updated | DATE NOT NULL, |
| primary_key(id) | |
| ) | |

Project table 831 has a record for all of the projects defined for a given database. As described above, every PR record is associated with a given Project, and thus, it can be said that all PRs in a database are “grouped” by their respective Projects. Similarly, a Project is associated with a given record in Division table 829, and thus, it can be said that all Projects in a database are further “grouped” by their respective Divisions.

This table contains the following data fields: (a) id: a unique ID in this table, (b) name: Project name, e.g., “Customer Support”, “R&D Work Items”, and “Assembly Line Controls”, (c) division_id: a specific Division ID that a given Project is associated with; thus enabling the grouping of Projects by Divisions, (d) project type: a value from a “Project Type” pick-list, with possible selections such as: “Manufacturing”, “Administrative”, and “Human Resources”, (e) created_by_rel_id: a specific ID of a person who created the given Project record in this table, (f) updated_by_rel_id: a specific ID of a person that last updated the given Project record in this table, (g) date_created: date/time that the given Project record was created in this table, (h) date_updated: the date and time that this record was last updated.

Division Table 829

A division table record looks like this:

| | |
|---|---|
| Division ( | |
| id | NUMBER (12) NOT NULL, |
| name | VARCHAR2 (80) NOT NULL, |
| created_by_rel_id | NUMBER (12) NOT NULL, |
| updated_by_rel_id | NUMBER (12) NOT NULL, |
| date_created | DATE NOT NULL, |
| date_updated | DATE NOT NULL, |
| primary key(id) | |
| ) | |

The Division table is a table that contains all Divisions defined for a given database. A Division is a group of Projects, and a Project is a group of PRs.

This table contains the following data fields: (a) id: a unique ID in this table, (b) name: Division name, e.g., “California Site”, and “New Jersey Site”, (c) created_by_rel_id: a specific ID of a person who created the given Project record in this table, (d) updated_by_rel_id: a specific ID of a person that last updated the given Project record in this table, (e) date_created: date/time that the given Project record was created in this table, (f) date_updated: the date and time that this record was last updated.

PR Activity Tables 835

PR_activity type table 837 contains the PR activity types for the activities performed manually by users of system 801 or automatically by system 801 itself when an administrative query returns a non-empty result set. PR_activity table 839 is the collection of all activities, of either class, that were performed or are scheduled to be performed for all the processes represented by PR records in PR table 833.

PR_activity_type Table 837

A record in PR_activity_type table 837 looks like this:

| | |
|---|---|
| PR_activity_type ( | |
| id | NUMBER (12) NOT NULL, |
| is_admin | NUMBER (1) NOT NULL, |
| name | VARCHAR2 (80), |
| can_schedule | NUMBER (1), |
| min_members | NUMBER (2) NOT NULL, |
| require_summary | NUMBER (1) NOT NULL, |
| summary_prompt | VARCHAR2 (120), |
| can_edit | NUMBER (1) NOT NULL, |
| edit_summary_only | NUMBER (1) NOT NULL, |
| date_updated | DATE NOT NULL, |
| primary_key(id) | |
| ) | |

Each record in PR_activity_type_table 837 represents a PR activity type. If the value of the is_admin field is 1, the record belongs to Admin_activity_type subtable 841 and represents an Admin activity type. The PR_activity table contains the following data fields: (a) id: a unique ID in this table, (which unique ID is referred to as pr_activity_type 609 by related tables seen in FIGS. 2 and 3), (b) is_admin described above; (c) name: a specific name given to the PR Activity Type, e.g., “Call Customer”, “Work Initiated”, and “Close-Done”, (d) can_schedule: if the value equals one, such a PR Activity Type can be scheduled by a user, otherwise, it can only be posted as a performed activity, (e) min_members: minimum number of activity participants that are required for the given PR Activity Type, (f) require_summary: if the value equals one, the given PR Activity Type can be performed only if an activity summary is entered, (g) can_edit: if the value equals one, a PR Activity performed using the given PR Activity Type can be edited, otherwise, it can not be edited at all, (h) edit_summary_only: if the value equals one, the summary of the PR Activity performed using the given PR Activity Type can be edited, otherwise, it can not be edited at all, and (i) date_updated: the date and time that this record was last updated.

When a record represents an Admin_activity_type, some of the fields have special values: can_schedule is not relevant, it is actually set to zero (0). Similarly, min_members=0, and require_summary and summary_prompt are set to “neutral”, meaningless values. The field can_edit is set to 0, as is edit_summary_only.

PR_activity Table 839

A record in PR_activity table 839 looks like this:

| | |
|---|---|
| PR_activity ( | |
| id | NUMBER (12) NOT NULL, |
| pr_id | NUMBER (12) NOT NULL, |
| pr_activity_type | NUMBER (6), |
| short_description | VARCHAR2 (120), |
| summary | LONG, |
| date_posted | DATE NOT NULL, |
| date_scheduled | DATE, |
| date_performed | DATE, |
| posted by_rel_id | NUMBER (12) NOT NULL, |
| updated_by_rel_id | NUMBER (12) NOT NULL, |
| responsible_rel_id | NUNBER (12), |
| status_origin | NUMBER (6), |
| status_after | NUMBER (6), |
| date_updated | DATE NOT NULL, |
| primary key(id) | |
| ) | |

PR_activity table 839 is a table that contains records representing activities that are scheduled to be or have been performed for processes represented by PR records. Each record indicates the activity's PR_activity type and the PR record for the process. When a record is added to PR_activity table 839 as a result of the scheduling or performance of an activity for a process, the activity is said to have been posted. A PR_activity record contains the following data fields: (a) id: a unique ID in this table. (b) pr_id: the ID of the record in PR table 833 with which this record is associated; (c) pr_activity_type: the identifier of a record in PR_activity_type table 837 that represents the activity's PR_activity_type, (d) short_description: a short summary of the activity, e.g., “Called customer to clarify request”, (e) summary: detailed description of the actions taken by the activity, (f) date_posted: date/time that the given record in the PR_activity table was created, (g) date_scheduled: date/time that the given PR Activity is scheduled to be performed, (h) date_performed: date/time that the given PR Activity was performed; this value is null if not yet performed, i.e., if still scheduled, (i) posted_by_rel_id: a specific ID of a person who posted the given PR Activity, (j) updated_by_rel_id: a specific ID of a person who last updated the given PR Activity, (k) responsible_rel_id: a specific ID of a person that is responsible for performing the given PR Activity, (l) status origin: a PR status that was in effect prior to performing the given PR Activity, e.g., “Opened”, (m) status_after: a PR status that went into effect after performing the given PR Activity, e.g., “Work in Progress”, and (n) date_updated: the date and time that this record was last updated.

When the activity represented by a record in PR_activity table 837 is an administrative activity, posting occurs only after system 801 has performed the administrative activity. System 801 automatically sets many of the above data fields to special values when it posts the record. The date scheduled is set to null, the date_performed is the then date/time that system 801 has posted the record, and the responsible_rel_id is set with a symbolic “admin” user, as is the posted_by_rel_id. Summary is set with an indication that “this activity is an administrative activity posted due to certain conditions with regard to the PR. Also included in the summary is the PR_query.description, i.e., the value in the ‘description’ field of the PR_query record for the administrative query whose execution caused the administrative action to be performed.

Administrative Query Tables 845

Admin_query table 853 contains a record for each of the administrative queries, referred to as Admin Query (AQ), which system 801 can make. An administrative query has the following components: a query (the query is an SQL query in a preferred embodiment); a scope specifier for the query. The scope specifier specifies a subset of the records in PR 833 over which the query will be run; a schedule specifier for the query; this contains information that system 801 uses to figure out when the query is to be executed; an initial administrative activity specifier, which specifies an administrative activity which will be performed when a PR record which is returned by an execution of the administrative query is in the state of First Occurrence with regard to the execution of the administrative query. An administrative query is further associated with a program sequence that specifies administrative activities that are performed for returns of the specific record in PR 833 by executions of the administrative query for which the record is in the state of Persistent Conditions with regard to the execution. The states of Persistent Conditions and First Occurrence will be described in more detail in connection with the discussion of log tables 871.

As shown in FIG. 2, the definition of each of the administrative query's components is contained in a record in another table that is referenced by the record in the Admin_query table 853; thus, the query is defined by a record in PR_query table 847, the scope by a record in AQ_scope table 849, the schedule by AQ_schedule table 851, and the initial administrative activity by the record in PR_activity_type table 837 for the initial administrative activity's Administrative activity type. One consequence of this arrangement is that queries, scopes, schedules, and Administrative activity types may be shared by any number of administrative queries, which greatly simplifies the configuration of administrative queries in system 801. Types of administrative activities which are performed when a PR record which is returned by an execution of an administrative query is in the state of Persistent Conditions with regard to that execution are specified in Program_sequence table 855.

The Admin_query table 853 specifies all the components of the Admin Query (AQ). Administrative queries are SQL queries. PR_query table 847 specifies the SQL FROM, WHERE, and ORDER clauses of the SQL query. A record in AQ_scope table 849 specifies a scope for an administrative query, that is, it defines a subset of the records in PR 833 over which the query is to run. In the preferred embodiment, the subset is defined by specifying selected projects defined in Project able 831. The subset is made up of all of the records in PR table 883 whose project_id fields specify records in Project able 831 for the selected projects. AQ_schedule table 851 and AQ_schedule_detail table 852 contain information that system 801 uses to schedule the next execution of an administrative query. A record in AQ_schedule table 851 specifies a schedule for executing an administrative query. A record in AQ_schedule detail table 852 specifies the schedule details for the AQ_schedule represented by the record in AQ_schedule table 851 referred to by the value in the aq_schedule_id field. The schedule detail determines when an administrative query that specifies the schedule will be executed.

When an administrative query that uses the AQ_schedule detail record is executed, the information in the AQ_schedule detail record is used to update the administrative query's record in current schedule table 823 to specify the next execution of the query. Where a time interval is specified, it is added to the time specified for the last execution of the query in the administrative query's record in current schedule table 823. The administrative query thus effectively schedules its next execution itself. One advantage of this arrangement is that the form of a record in current schedule table 823 is independent of the kind of scheduling being done; further, the table itself need have only one record for a given administrative query, regardless of the frequency with which the given administrative query is being executed or the complexity of its execution schedule.

Program_sequence table 855 specifies additional activities that can be performed for a process whose record in PR 833 has been retrieved by an execution of an administrative query with regard to which the retrieved PR record is in the state of Persistent Conditions. There may be a number of records in Program_sequence table 855 for a given administrative query. The set of records for the given administrative query is called the administrative query's program sequence. The program sequence associated with a given administrative query specifies administrative activities that are to be executed with regard to a PR record that is in a state of Persistent Conditions with regard to the current execution of the administrative query. The set of records specifies not only the administrative activities, but also the order in which they are performed by executions of the administrative query for which the PR record is in the state of Persistent Conditions, and the temporal conditions under which they are to be executed. The parts of a program sequence record that specify these things are termed instruction elements, and taken together, the instruction elements in a program sequence record define an instruction. In the preferred embodiment, each record in Program_sequence table 855 specifies a set of three instruction elements: a Type instruction element, an Admin Activity Type instruction element, and an Elapsed Time instruction element. The Type instruction element specifies the Program_sequence record that will be used the next time the query with which the program sequence record is associated is executed; the Admin Activity Type instruction element specifies the Administrative activity type of the activity to be performed and is thus a pr_activity_type field 609 referencing Admin_activity_type subtable 841; the Elapsed Time instruction element specifies a minimum time from the time the last administrative activity was executed by the query for a given PR record to the time the administrative activity specified by this Program_sequence record is to be executed. Other embodiments may have different instruction elements and more or fewer of them.

Admin_query_log table 873 and AQ_PR_log 875 together contain the information that system 801 uses to determine when to perform the next administrative activity for a PR record returned by an execution of a given administrative query and what administrative activity the next administrative activity should be.

Admin_query_log table 873 logs the execution of every administrative query by system 801. There is a record for every execution of each of the administrative queries. The AQ_PR_log table 875 has a record corresponding to each PR record returned by a given execution of an administrative query. This record further contains the Next Sequence Pointer that determines which Administrative activity type will next be executed by system 801 for the given query and PR record. AQ_PR_log table 875 logs PR records that were returned when a given administrative query was executed. Each record represents a particular PR record-administrative query execution pair.

AQ_trends table 879 logs information which system 801 can use to determine trends in the way in which the processes being monitored by a given administrative query are behaving and to perform administrative actions as determined by those trends.

There may be a record in this table for every administrative query for which trends are being tracked. The record for a given administrative query can be configured to recognize trends over a particular time interval in the number of PR records returned by executions of the given administration query and to specify administrative activities for particular trends. When a particular threshold is reached and detected during an execution of the administrative query, the execution of the administrative query may result in the performance of an administrative action on a particular PR record that is separate from the PR records returned by the administrative query. The interaction between the record for an administrative query in the AQ_trends table and executions of the administrative query is another example of conditional performance of an administrative action based on a condition that is detected during execution of the query.

One administrative activity specified in the AQ_trends table record may set a field in the separate PR record indicating that the threshold for a trend in one direction has been exceeded, and another may reset that field if a trend is below the given threshold. The determination of “exceeding” the threshold or going “below” a given threshold is dependent on a direction qualifier. Another administrative query may query PR records set by these administrative activities and when one of these records is in a state of Persistent Conditions over time, indicating that a trend is continuing, an execution of the other administrative query may result in performance of an administrative activity that notifies someone or takes some other action to remedy the trend.

Action Tables 857

The actions performed by system 801 when it executes a given Administrative activity type are described in records in action tables 857 whose pr_activity_type fields contain the unique identifier of the given Administrative activity type's record in PR_activity type table 837. There are a number of kinds of actions, and each kind has its own table in action tables 857. If an Administrative activity type is seen as a kind of program, the actions associated with a given Administrative activity type can be seen as the Administrative activity type's instructions. As with normal program instructions, the action performed by a given program instruction may depend on a value that is obtained at runtime. When the actions belonging to a given administrative activity are executed, they are executed in the order given by the values of the action records' identifiers. In other embodiments, there may be other provisions for establishing an order in which the actions are executed and there also may be provisions for gotos and conditional branches. The present invention has the ability to easily modify pre-existing Administrative activity types. To modify an administrative activity type, one needs only modify the records in action tables 857 for the actions belonging to the administrative activity type, either by adding or deleting records or editing existing records. Modification of an administrative activity is not only easy, but safe, since the modifications are constrained by the fields available in the action records being added, deleted, or edited.

In a preferred embodiment, there are three broad classes of actions: those which modify a PR record which belongs to the result set returned by an administrative query; those which post records for activities to the PR_activity table, and one action which generates a report about the PR records in the result set returned by the administrative query. The relationship between these classes of actions and the kinds of actions are as follows:

Kinds of actions which modify PR records: AA_set_values actions in table 859: these actions set or increment fields in PR records that contain neither person nor date values. AA_set_person actions in table 863: these actions set fields in PR records that contain person values. A person value is an identifier for a person known to system 801. AA_set_dates actions in table 861: these actions set fields in PR records that contain date values. The date fields are set with reference to other date fields in the PR records or with reference to the date and time when an administrative activity is performed.

Kinds of actions which post records in PR_activity table 839: AA_post_activities actions in table 865: these actions post records for any kind of activity type in PR_activity table 839. The posting may either schedule an activity for performance or indicate that the activity has been performed. PR_notification actions in table 865: these actions generate and send a notification to a list of people that is associated with the processes PR record, post a record to PR_activity table 839 for the notification, and makes a record in another table (not shown) which indicates who received notifications.

Report generating actions: AA_exec_report actions in table 865: generates a report which includes all the PR records of the result set returned by the administrative query that is performing the administrative activity that contains the action, formats the report based on a specified report template, converts its to a PDF file, and mails out the PDF file as an attachment to recipients based on a configurable recipient list.

An action table record associated with a given Administrative type may come from any of the action tables and an Administrative type may have any number of action table records associated with it. To clarify by example, for a given Administrative activity type, system 801 can be configured to have no records in AA_set_values actions table 859, which means that upon performing this given Administrative activity type, there will be no effect on any non-date or any non-person field values in the matching PR records; one record in the AA_set_person actions table 863, indicating one specific person field to be affected; and three records in AA_set_dates actions table 861, indicating three specific date or date-time fields to be affected by this given Administrative activity type. The same is true for the other kinds of actions.

It should be pointed out here that in general, the kinds of actions defined for an embodiment of the invention will depend on the kind of process being controlled by the invention. The kinds of actions in the preferred embodiment are typical for embodiments that are intended to control business and administrative processes. Embodiments that are intended to control industrial or technical processes may have actions that result in physical actions being performed. Examples might be sounding an alarm, adjusting a valve, or rerouting a stream of packets. The details of the action tables are presented in the order of the above taxonomy.

Auto Numbering User-Defined Field Type

In some applications, the ability to track the process using unique identifiers is desirable or required. To implement the unique identifier generation, the present invention provides an auto numbering field as a user defined field, which can be added to a PR record similarly to adding any other user defined field.

The auto numbering field is a string, which will be set automatically by the system 801 whenever a PR record enters one of the pre-defined states in the workflow. Configuration of the auto numbering field specifies how the string will be set by way of specifying “sources” and by specifying how these sources will be concatenated. The result of each source is a “component” of an auto numbering field.

When a PR record enters one of the pre-defined states in the workflow, the given auto numbering field will be set, based on its configured sources, but provided that all given sources have a value. Since the auto numbering field value is derived from the sources, if any of the sources does not have a value, then the auto numbering field value cannot be derived. In this case, the auto numbering field will not be set, i.e., will remain blank.

Once generated, the auto numbering field value will be inserted into a data field in a PR record with a unique index on the auto number value and the ID of the auto number configuration combination. This will avoid the generation of duplicate auto number values for a given data field.

Auto number configuration is specific to a record type and a class. The record type can be found in the project_type field in the record in Project table 831. A class contains one or more auto numbering fields per record type. When adding auto numbering data fields to a class, only fields associated with the same record can be added. Then the class is associated with a Project. Whenever a PR is saved and enters a certain state, the system 801 determines which auto numbering fields, if any, need to be considered based on the auto numbering class that the given Project is associated with.

Configuration of an Auto Numbering Field

Sources

Administrative users of the system 801 can configure auto numbering fields with any of the following possible sources: (a) any string field; (b) any single selection field, including Division and Project (in the preferred embodiment, excluded are the five classification fields, the version, and the fix version fields); (c) date or date/time field; (d) a counter, i.e., generating a sequential number; and (d) a constant string, e.g., “R-12”. The first two types of sources are herein referred to as alpha numeric sources.

Configuration of auto numbering fields specifies the following: (a) for each source, the PR where the corresponding field value should be taken from, such as the PR itself, the parent PR, or the root parent PR; (b) a specific configuration for the characters to be taken from the source, resulting in an auto numbering component; (c) the order in which these components should be concatenated; and (d) an inter-component prefix and/or suffix, specified per component. All components are then concatenated, resulting in a specific value for the given auto numbering field based on the value of the sources at such time.

Inter-Component Prefix and Suffix

The inter-component prefix and/or suffix can be a character or combination of characters. The following combinations are allowed: (1) prefix only; (2) suffix only; (3) prefix and suffix; or (4) none. Prefix or suffix characters may include the space character “ ”, a period “.”, dash “-”, colon “:”, or a combination thereof. For example, assume that the first source results in a first component, “CCS”, and the second source (a counter) results in a second components, “00345”. Also assume that the prefix and the suffix for the first source is none, the prefix for the second source is a dash “−”, and the suffix for the second source is blank, then the auto numbering field would be set with the string value “CCS-00345”.

If the auto numbering field value is such that it is not to begin with a space, dash, etc., then an inter-component prefix cannot be specified for a first component placed in an auto numbering field, and an inter-component suffix cannot be specified for a last component of an auto numbering field.

Configuring Components Derived from Alpha Numeric Sources

Once the source field is selected, its configuration of the source field depends upon the field type, as follows:

Counter. A counter is a unique sequential number based on the string preceding the counter in the auto number field. The counter is incremented for every new instance of the auto numbering field where the given counter is used. The length of the counter is specified with specifying the number of significant digits for the counter. When concatenating a counter into an auto numbering field, it will be presented with leading zeros. For instance, the number 5 would represent that a minimum of 5 digits will be displayed to include leading zeros. If during processing the counter value exceeds the configured number of digits, then the actual counter value will be used. For instance, if the counter length is 5 digits, but the next sequential number for a given PR is 100,000, then 100000 will be appended to the auto number.

A counter can be set to reset itself on a monthly or annual basis, if it is related to a specified Date of Date/Time source field. For example, assume that a five-digit counter is associated with the “Date Opened”, and the reset is defined as Annual. If it is the 345^{th} PR record created in the given year (based on “Date Opened”), the value of the counter will be “00345”, the next value within the same given year will be “00346”, etc. However, the value for a PR record saved with “Date Opened” in a following year will restart with the value “00001”. Using this example, it is possible that when PR records are imported with a “Date Opened” in a multi-year range, that the auto numbering of such PR records will represent a sequential number within the respective years, as derived from the “Date Opened”.

The uniqueness of a counter is defined per the following:

a. In cases where a counter is not configured to be associated with a Date or Date/Time field, i.e., values for such a counter keep incrementing forever. These values will therefore be unique among themselves for the given auto numbering field.

b. Counters which are associated with a Date or Date/Time field and are specified to reset on an annual basis are concatenated with the YYYY component of such sources to ensure uniqueness. Whereas, counters that reset on a monthly basis have both the YYYY and the MM or MMM components of such referenced Date or Date/Time field to ensure uniqueness.

c. The concatenation of any of the components of the auto numbering field plus the counter must be unique.

For example, assume that the auto numbering field is configured where the first component is derived from the Project and the second component is a five-digit counter. The following specific values are allowed: CCS-00345 and COF-00345. Note that these particular values represent complaint number 345 in Project “Complaints—Customer Service”, and complaint number 345 in “Complaints—Order Fulfillment”. Hence, the uniqueness in this case is defined as the combination of these two components.

Level Counter. A level counter is a unique sequential number based on the project and record type. A level counter can only be used for children records. The length of the level counter is specified by specifying the number of significant digits for the counter. For instance, the number 3 would represent that a minimum of 3 digits will be displayed to include leading zeros. If during processing the counter value exceeds the configured number of digits, then the actual counter value will be used. For instance, if the counter length is 3 digits, but the next sequential number for a given PR record is 1000, then 1000 will be appended to the auto number. Configuration includes the option to count the first child record (assign the first child record a unique number) or to skip numbering the first child record. If both a counter and level counter are used, the level counter must have a higher sequence number.

An auto numbering field can be configured to simply copy the value of a given auto number field from the parent PR, the root parent PR, or a sibling PR. With a copying from a sibling PR, the first child, having no siblings yet, will be assigned a new auto number, but siblings will have the same auto number. This will be done by specifying the auto number field as the component, and specifying the source as the Parent, Root Parent, or Sibling.

The auto numbering field can be further configured to automatically append level counters. For example, assume that a given auto numbering field can be configured to copy from an auto numbering field from the Root Parent PR. The string “-001” will be appended for the first created grandchild, “-002” for the second created grandchild, etc.

Optionally, the first child PR at a given level will be assigned an auto number value based on a given configuration, but without appending “-001”. For siblings created thereafter, the auto number from the first PR record at that level would be copied and “-001”, “002”, etc. would be appended.

Constant String. A constant string is a fixed alpha numeric value. It is configured by entering the alphanumeric value.

Single Selection Fields and String Fields. A single selection value is from a root parent PR, the parent PR, or the fetched PR. Possible configurations include: use all capital letters; same number of characters from each word; use exact value; and distinct settings per word. Component level prefix and suffix, and word separators/tokens, can also be configured.

Component level prefix and suffix. A distinct Prefix and Suffix can be specified for concatenating the resulting character combination taken from each word from a source. Similar to the inter-source prefix and suffix, either one can be empty, i.e., no character, or define a character or combination of characters for the prefix and/or suffix. For example, assume the configuration is: “Take the first character from the first word and the entire second word from Project”, then the prefix and the suffix for the first word is none, the prefix for the second word is dash “-”, and the suffix for the second word is none. For the Project “Complaints NJ”, the resulting component will be C-NJ”.

There will be cases where a consistent number of words in an alpha numeric source cannot be expected, e.g., using the “Project” field as a source, where Projects can be “Complaints—HVAC” (two words), “Complaints—Response Time” (three words). In these cases, one can specify “take ‘n’ characters from each word of the given source”. In which case, a single set of prefix and suffix will be applied for the character combination taken from all words, however, the prefix will not be applied to the first word and the suffix will not apply to the last word. For example, assume the rule is “take the first character from each word in Project”, the prefix for concatenation is dash “-”, the suffix is none, and the project is “Corrective Actions”. The result will be “C-A”. Using this example, but where the prefix for concatenation is none, the result will be “CA”.

Tokens. Tokens are word separators within the source data field. A token is a single character or a string of characters such as a space, semi-colon, dash, or a combination of characters such as two dashes. If more than one token is specified, tokenizing a source data field into words will use the OR logic. For example, assume that two separators are defined, the first separator being the combination of space, dash, and space “-”, and the second separator being a single space character “ ”. Assume also that the source is “Project” and a given Project is “Complaints Customer Service”. The result will be the following words: “Complaints”, “Customer” and “Service”.

Tokenizing a source into words can also be specified as “combinations of contiguous characters residing in the group of the following ranges: [0-9], [A-Z], and [a-z]. For example, using this separator rule, tokenizing “Complaints—Order Fulfillment” will result in the words “Complaints”, “Order”, and “Fulfillment”. This is similar to the previous example but is using a simpler definition for the separator. For another example, using this separator rule, tokenizing “Aspirin—81 mg” will result in the words “Aspirin” and “81 mg”.

If the configuration specifies the use of a word that does not exist, then the tokenizing rule will be ignored. For instance, if the configuration indicates that one character from the fourth word in “Material Code” will be used, but the given Material Code is tokenized into three words only, then no character, no prefix and no suffix will be placed as a result of this particular configuration rule for this given Material Code.

Use all capital letters. Selecting this option will use only the capital letters from the source field. This option also includes the ability to specify component level prefix and suffix, and word separators/tokens. For instance, if the auto number field is configured to use all capital letters and includes Title and Counter, then the auto number field where the Title is The temperature of the storage facility is high would be represented as T-001 where is used as a suffix to Title.

Same number of characters from each word. Selecting this option will take a fixed number of characters from each word in the selection value or string. This option also includes the ability to specify the following: specify the number of characters for each word; use component level prefix and suffix; capitalize the value; and word separators/tokens. For instance, if the auto number field is configured to use 3 characters from each word and includes Title and Counter, then the auto number field where the Title is The temperature of the storage facility is high would be represented as Thetemof thestofacishig-001 where - is used as a suffix to Title. The number of characters to be taken from a word represents the maximum number of characters to be taken from that word. If the word has fewer characters, then only those characters will be taken.

Use Exact Value. Selecting this option will use the exact content of the selection value or string. For instance, if the auto number field is configured to use 3 characters from each word and includes Title and Counter, then the auto number field where the Title is The temperature of the storage facility is high would be represented as The temperature of the storage facility is high-001 where - is used as a suffix to Title.

Distinct settings per word. This option allows the configuration of individual words in the component that comprise the auto number field. Selecting this option enables configuration of unique settings for each word in the Selection Value or String to include the following: use all capital letters; use whole word; number of characters; capitalize value; prefix; suffix; and sequence number.

Configuring Components to be Derived from a Date or Date/Time Field

A component can be configured to be derived from a Date or Date/Time field as a source. The year, or the month and year, results from specifying a date or date/time field on the root parent PR, the parent PR, or the fetched PR. It is configured by selecting the date format to be included in the auto number.

In the preferred embodiment, one of the following formats is selected for this component: (1) YYYY: that is, “take the year from the given source, e.g., “2006”; (2) MM: that is, “take the month of the source field” and represent it using two digits, e.g., “06” for June, “09” for September, etc.; or (3) MMM: that is, “take the month of the source field” and represent it using international month coding, that is “JAN”, “FEB”, etc.

In the case where a counter is specified to reset on a monthly basis, both the YYYY component and either the MM or MMM components of the associated Date or Date/Time field must be configured for the auto numbering field. This is required to ensure uniqueness of the auto numbering field values along time. For example, an auto numbering field is specified based on Project, “YYYY” referencing “Date Opened”, and a five-digit counter, which resets annually. The resulting auto numbering field value is “CCS-2006-0345”, reading as the 345^{th} instance of “Complaints Customer Support” in 2006.

Auto Numbering Change Log

In cases where an auto numbering field is updated, resulting in a different value when any of the sources have changed, then a log will be generated. This log table will store at least the following information: PR ID; Date Field ID; Previous value; Current value; Date/Time of change; User ID; Reason for the change; and Comments for the change.

Database Schema for Auto Numbering User-Defined Fields

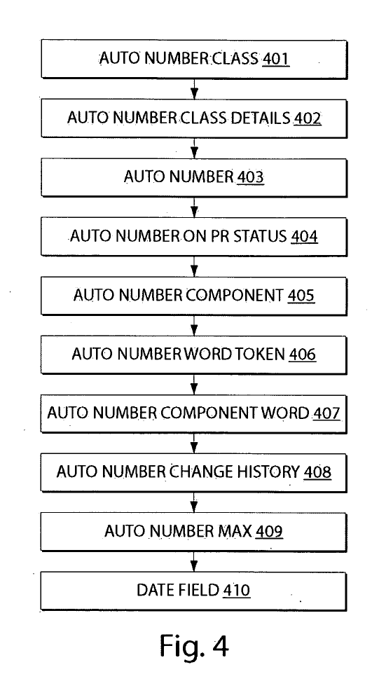

FIG. 4 illustrates the database tables that implement the auto number user-defined fields in the system 801. The tables include:

Auto_number_class table 401 for specifying an auto numbering class;

Auto_number_class_details table 402 for specifying which auto numbering data fields are included in a given class;

Auto_number table 403 for specifying the configuration of an auto numbering user-defined field for a given record type;

Auto_number_on_pr_status table 404 for specifying the PR states in which the auto number needs to be generated;

Auto_number_component table 405 for specifying the component to be used for generating or updating an auto numbering user-defined field;

Auto_number_word_token 406 for specifying the separators to be used for tokenizing an alpha numeric source field;

Auto_number_component_word table 407 for specifying what to do with words taken from a source to build a component;

Auto_number_change_history table 408 for storing the change history of auto numbering values;

Auto_number_max table 409 for storing the value for each auto numbering user-defined fields, per record type, which were ever set; and

Data_fields table 410 for defining a user-defined field, including auto numbering user-defined fields.

The above tables are described in more detail below:

The Auto_number_class table 401 specifies an Auto Numbering class, which class can then be associated with a Project. There is a record for each auto number class. This class is a place holder defining which Auto Numbering data fields should be generated for a given Project. The association between the Project and the auto number class is accomplished through the following statement:

ALTER TABLE Project ADD auto_number_class_id NUMBER(12)

A record in the Auto_number_class table 401 looks like this:

| CREATE TABLE Auto_number_class | |
|---|---|
| ( | |
| id | NUMBER(12), |
| name | VARCHAR2(1016), |
| record_type | NUMBER(12), |
| date_updated | DATE |
| ) | |

| Column Name | Comments |
|---|---|
| id | Unique Identifier for each row |
| name | The name of the given class |
| record_type | Points to: Record_type.id in the Project table. |
| | Represents the record type of this class. |
| date_updated | Date/Time of most recent updated of the given |
| | row. Value is stored in GMT. |

The Auto_number_class_details table 402 specifies which Auto Numbering Data Fields are included in a given class. There is a record for each auto numbering data field belonging to the given class. A record in the Auto_number_class_details table 402 looks like this:

| CREATE TABLE Auto_number_class_details | |
|---|---|
| ( | |
| id | NUMBER(12), |
| auto_number_class_id | NUMBER(12), |
| auto_number_id | NUMBER(12), |
| date_updated | DATE |
| ) | |

| Column Name | Comments |
|---|---|
| id | Unique Identifier for each row |
| auto_number_class_id | Points to: Auto_number_class.id in the |
| | Auto_number_class table |
| auto_number_id | Points to: Auto_number.id in the |
| | Auto_number table |
| date_updated | Date/Time of most recent updated of the given |
| | row. Value is stored in GMT. |

The Auto_number table 403 is the main table specifying the configuration of a given auto numbering user-defined field for a given record type. There is a record for each auto numbering user-defined field for a given record type. For a given auto numbering class, a given auto numbering user-defined field can be included only once. A record in the Auto_number table 403 looks like this:

| CREATE TABLE Auto_number | |
|---|---|
| ( | |
| id | NUMBER(12), |
| data_field_id | NUMBER(12), |
| record_type | NUMBER(12), |
| accept_changes | NUMBER(2), |
| date_updated | DATE |
| ) | |

| Column Name | Comments |
|---|---|
| id | Unique Identifier for each row |
| data_field_id | Points to Data_fields.id in the Date_field table. |
| | Represents the field for which the Auto |
| | Numbering configuration applies |
| record_type | Points to: Record_type.id in the Project table. |
| | Represents the Record Type for which this Auto |
| | Numbering field configuration applies |
| accept_changes | Possible values: 0/1. Value of 1 means that if |
| | any of the source fields change, then the Auto |
| | Number will be recalculated when the record is |
| | in one of the allowed states. |
| date_updated | Date/Time of most recent updated of the given |
| | row. Value is stored in GMT. |

The Auto_number_on_pr status table 404 specifies the PR states in which the auto number needs to be generated (or updated if “accept_changes=1”). There is a record for each PR state for each auto number. Please note that defining these States refer to particular configuration of auto numbering user-defined fields in a given Record type. A record in the Auto_number_on_pr_status table 404 looks like this:

| CREATE TABLE Auto_number_on_pr_status | |
|---|---|
| ( | |
| id | NUMBER(12), |
| auto_number_id | NUMBER(12), |
| pr_status_type | NUMBER(12), |
| date_updated | DATE |
| ) | |

| Column Name | Comments |
|---|---|
| id | Unique Identifier for each row |
| auto_number_id | Points to: Auto_number.id |
| pr_status_type | Points to: PR_status_type.id. Represents a PR |
| | State where the Auto Number is to be generated |
| | (or updated). |
| date_updated | Date/Time of most recent updated of the given |
| | row. Value is stored in GMT. |

The Auto_number_component table 405 specifies the component to be used for generating (or updating) a given auto numbering user-defined field. There is a record for each component of an auto number. A record in the Auto_number_component table 405 looks like this:

| CREATE TABLE Auto_number_component | |
|---|---|
| ( | |
| id | NUMBER(12), |
| auto_number_id | NUMBER(12), |
| data_field_id | NUMBER(12), |
| use_record_type | NUMBER(2), |
| source | NUMBER(12), |
| date_format | VARCHAR2(4), |
| constant_string | VARCHAR2(320), |
| level_counter | NUMBER(2), |
| count_first_child | NUMBER(2), |
| prefix | VARCHAR2(40), |
| suffix | VARCHAR2(40), |
| capitalize_value | NUMBER(2), |
| is_counter | NUMBER(2), |
| counter_length | NUMBER(2), |
| group_non_alpha_numeric | NUMBER(2), |
| n_chars_each_word | NUMBER(8), |
| use_all_capital_letters | NUMBER(2), |
| use_component_prefix_suffix | NUMBER(2), |
| seq_no | NUMBER(8), |
| date_updated | DATE |
| ) | |

| Column Name | Comments |
|---|---|
| id | Unique Identifier for each row |
| auto_number_id | Points to: Auto_number.id in the Auto_number table. |
| data_field_id | Points to: Data_fieds.id in the Data_fields table. |
| | Represents the field whose value will be used as |
| | a source for the given Component. |
| use_record_type | Possible values: 1/0. Value of 1 means that |
| | the Record Type (Record_type.name) will be |
| | used for the given Component. |
| source | Possible values: 0 = Fetched PR; 1 = Parent |
| | PR; 2 = Root Parent PR. Relevant only if |
| | “Data_field_id” or “use_record_type” is specified. |
| date_format | Possible values: YYYY, MMM, MM. Applies |
| | only if the specified “data_field_id” is a Date or |
| | Date/Time field. |
| constant_string | Constant String to be used (in its entirety) for |
| | the given Component. |
| prefix | Prefix for the given Component (can be empty) |
| level_counter | Possible values: 0/1. Value of 1 means that a |
| | counter will be generated for a given level in the |
| | parent-child hierarchy. Note: Relevant also in |
| | the case that “copy_from_source” is null. |
| count_first_child | Possible values: 0/1. Value of 1 means that the |
| | first child will counted as #1 on the given level, |
| | otherwise the second child will be counted as #1 |
| | on the given level. Note: Applicable only if |
| | “level_counter = 1” |
| suffix | Suffix for this given Component (can be empty) |
| capitalize_value | Possible values: 1/0. |
| is_counter | Possible values: 1/0. Value of 1 means that |
| | this component is a Counter. |
| counter_length | Determines the length of the counter value. If |
| | the resulting counter is less than this value it |
| | will be padded with zeros (e.g. 00250). |
| group_non_alpha_numeric | Possible values: 1/0. Value of 1 means that all |
| | non-alpha numeric characters will be used to |
| | tokenize the words in this component |
| n_chars_each_word | If set, then take ‘N’ characters from each word in |
| | the given component |
| use_all_capital_letters | Possible values: 1/0. Value of 1 means that all |
| | capital letters in the component will be used |
| use_componenet_prefix_suffix | Possible values: 1/0. Value of 1 means that |
| | component level prefix and suffix will be used |
| | to separate words. This setting can be used only |
| | in conjunction with n_chars_each_word and |
| | use_all_capital_letters. |
| seq_no | Determines the order of the components in this |
| | Auto Number |
| date_updated | Date/Time of most recent updated of the given |
| | row. Value is stored in GMT. |

The following is the table of all possible (valid) combinations of “Date/Time” fields, “Date Format” and “Is Counter”

| Data_field_id | | | |
|---|---|---|---|
| is Date | | | |
| or Date/ | Date_format | is_counter = | |
| Time field | specified | 1 | Comments |
| FALSE | FALSE | FALSE | OK. This is neither a |
| | | | counter nor a Date |
| | | | Component. |
| FALSE | FALSE | TRUE | OK. This will be a counter, |
| | | | which may reset based on |
| | | | the preceding string value. |
| FALSE | TRUE | FALSE/ | Invalid |
| | | TRUE | |
| TRUE | FALSE | FALSE/ | Invalid |
| | | TRUE | |
| TRUE | TRUE | FALSE | OK. This component just |
| | | | shows a Date format (of the |
| | | | referenced Date Field) |
| TRUE | TRUE | TRUE | Invalid |

Note that only one date component can be configured anywhere before a counter component for a given auto numbering configuration. Only one counter component can be specified for an auto numbering configuration. If a MM or a MMM component is specified, then validation will require a YYYY component immediately preceding the monthly component. It is possible to have and date components after a counter component, e.g., “Complaints-NJ-0010452-Created on: 2007-Mar”, where “Complaints” is a component derived from “Project”, “NJ” is derived from “Division”, “0010452: is a counter, “Created on” is a constant, and “2007-Mar” is a date component (possibly referencing “Date Opened”).

The Auto_number_word_token table 406 specifies the separators to be used for tokenizing an alpha numeric source field. There is a record for each separator for an alpha numeric source field. A record in the Auto_number_word_token table 406 looks like this:

| CREATE TABLE Auto_number_word_token | |
|---|---|
| ( | |
| id | NUMBER(12), |
| auto_number_component_id | NUMBER(12), |
| separator | VARCHAR2(20), |
| date_updated | DATE |
| ) | |

| Column Name | Comments |
|---|---|
| id | Unique Identifier for each row |
| auto_number_component_id | Points to: Auto_number_component.id. |
| separator | Token that will be used to parse for the |
| | given word, e.g., “—” |
| date_updated | Date/Time of most recent updated of the |
| | given row. Value is stored in GMT. |

The Auto_number_component_word table 407 specifies what to do with words taken from a source to build a component. There is a record for each specification for a component. A record in the Auto_number_component_word table 407 looks like this:

| CREATE TABLE Auto_number_component_word | |
|---|---|
| ( | |
| id | NUMBER(12), |
| auto_number_component_id | NUMBER(12), |
| word_number | NUMBER(12), |
| n_chars | NUMBER(12), |
| whole_word | NUMBER(2), |
| capitalize_value | NUMBER(2), |
| use_all_capital_letters | NUMBER(2), |
| prefix | VARCHAR2(40), |
| suffix | VARCHAR2(40), |
| seq_no | NUMBER(8), |
| date_updated | DATE |
| ) | |

| Column Name | Comments |
|---|---|
| id | Unique Identifier for each row |
| auto_number_component_id | Points to: Auto_number_component.id in |
| | the Auto_number_component table. |
| n_chars | Determines the number of characters to |
| | use, starting with the 1^{st} character in the |
| | word |
| word_number | Determines the sequential number of the |
| | word |
| capitalize_value | Possible values: 1/0. |
| use_all_capital_letters | Possible values: 1/0. Value of 1 means |
| | that all capital letters in the word will |
| | be used |
| prefix | Prefix for this Auto Number Word |
| suffix | Suffix for this Auto Number Word |
| seq_no | Determines the position of this word in the |
| | Auto Number field value. |
| date_updated | Date/Time of most recent updated of the |
| | given row. Value is stored in GMT. |

The Auto_number_change_history table 408 stores the change history of auto numbering values. Such changes are possible when a given auto numbering field gets recalculated when any of its sources changes, and when “Accept Changes” is allowed, and the corresponding PR is in one of the allowed states. There is a record for each change to an auto numbering value. A record in the Auto_number_change_history table 408 looks like this:

| CREATE TABLE Auto_number_change_history | |
|---|---|
| ( | |
| id | NUMBER(12), |
| pr_id | NUMBER(12), |
| auto_number_id | NUMBER(12), |
| prev_value | VARCHAR2(1016), |
| current_value | VARCHAR2(1016), |
| person_rel_id | NUMBER(12), |
| person_name | VARCHAR2(328), |
| comments | VARCHAR2(1016) |
| date_updated | DATE |
| ) | |

| Column Name | Comments |
|---|---|
| id | Unique Identifier for each row |
| pr_id | Points to: PR.id in the PR table. The ID of the |
| | PR record where the Auto Number value was |
| | changed |
| auto_number_id | Points to: Auto_number.id in the Auto_number |
| | table. The ID of the Auto Number field that |
| | changed. |
| prev_value | The value of the Auto Number field prior to the |
| | change |
| current_value | The value of the Auto Number field after the |
| | change |
| person_rel_id | Points to: Person_relation.id. The ID of the |
| | Person who changed the value of the Auto |
| | Number field |
| person_name | The name of the person who changed the value |
| | of the Auto Number field. Stored in this table in |
| | case the name in the Person_relation is |
| | modified. |
| comments | The comments for the change. |
| date_updated | Date/Time of most recent updated of the given |
| | row. Value is stored in GMT. |

Note that “Meaning” and “Comments” will be automatically set by the updating process.

The Auto_number max table 409 stores the value for each auto numbering user-defined fields per record type, which were ever set. This table is used to increment the counter. There is a record for each value of an auto numbering user-defined field. A record in the Auto_number_max table 409 looks like this:

| CREATE TABLE Auto_number_max | |
|---|---|
| ( | |
| auto_number_prefix | VARCHAR2(1016), |
| auto_number_value | NUMBER(12), |
| auto_number_id | NUMBER(12), |
| date_updated | DATE |
| ) | |

| Column Name | Comments |
|---|---|
| auto_number_prefix | The string value (up to the counter) |
| auto_number_value | The numeric value of the counter as used last |
| auto_number_id | Points to: Auto_number.id |
| date_updated | Date/Time of most recent updated of the given |
| | row. Value is stored in GMT. |

The Data_fields table 410 defines the user-defined fields in the database system 825. A record in the Data_fields table 410 looks like this:

| CREATE TABLE Data_fields ( | |
|---|---|
| ( | |
| id | NUMBER(12) NOT NULL, |
| field_type | NUMBER(6), NOT NULL, |
| name | VARCHAR2(40), |
| name_dft | VARCHAR2(40), |
| copy_to_child | NUMBER(2) NOT NULL, |
| is_visible | NUMBER(2) NOT NULL, |
| date_updated | DATE NOT NULL, |
| primary key(id) | |
| ) | |

| Column Name | Comments |
|---|---|
| id | Unique ID in this table; can be used as an |
| | identifier for the user-defined field |
| field_type | Pre-defined numeric constant which specifies |
| | the type of the user-defined field; would |
| | indicate this is an auto numbering field here |
| name | Name given to the filed |
| name_dft | System name, not customizable by a user |
| copy_to_child | Boolean value, TRUE: indicates that when child |
| | PR is created, value of this column should be |
| | copied from parent PR record; FALSE: no such |
| | copy |
| is_visible | Boolean value, TRUE: indicates that this field is |
| | visible in data entry forms and reports; FALSE: |
| | not visible |
| date_updated | Date and time this record was last updated |

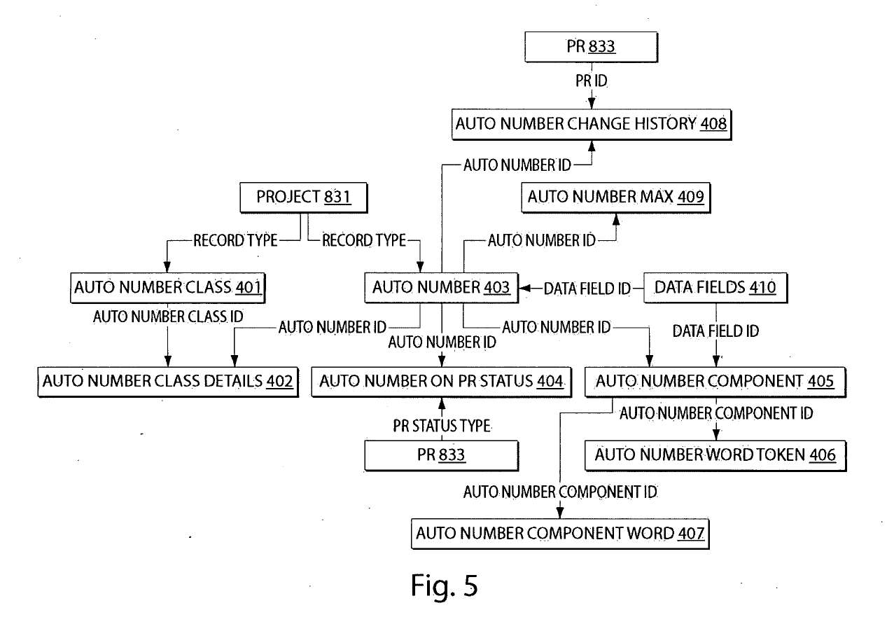

Entity-Relationship Diagrams for Auto Numbering User-Defined Fields: FIG. 5

FIG. 5 is an entity-relationship diagram which shows relationships between the database tables of system 801 which implement the auto numbering user-defined fields. As with FIGS. 2 and 3, boxes representing the tables of FIG. 5 are connected by arrows that are labeled with the name of the field whose value is a unique identifier for a record in the table which is the source of the arrow. Values from that field also appear in the records of the table which is the destination of the arrow and relate those records to the record whose unique identifier they contain. The relationship between a record in the table which is the source of the arrow and records in the table which is the destination is generally one-to-many, but is in some cases one-to-one.

Generation of Auto Numbers by System 801

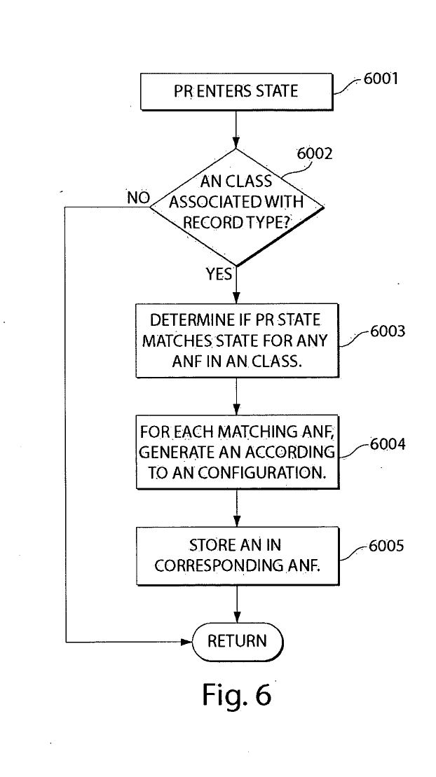

FIG. 6 is a flowchart illustrating the generation of auto numbers by the system 801. When a PR record is saved and enters a state (step 6001), the system 801 determines if there are any auto numbering (AN) classes associated with the record type of the PR record (step 6002). If so, then the system 801 next determines if the PR record state matches the PR state for any of the auto numbering fields (ANF) in the AN class (step 6003). For each ANF matching the PR state, the AN is generated according to the AN configuration (step 6004). The AN is then stored in the corresponding ANF (step 6005).

More specifically, when a PR record is saved and enters a state (step 6001), the system 801 determines if the PR record has an auto_number_class_id field. If so, the system 801 finds records in the auto_number_class table 401 with the auto number class_id and makes sure that the record_type in this record matches the record type of the PR record (step 6002). The system 801 next finds all the records in the auto_number_class_details table 402 with the auto_number_class_id, and gets the auto_number_id's from these records. This gives the system 801 the auto numbering data fields included in the given class. The auto_number_id's reference records in the auto_number table 403.

For each auto_number_id, the system 801 finds the record in the auto_number on_pr_status table 404 with the auto_number_id, and gets the pr_status_type from this record. The pr_status_type is then compared with the PR record status (step 6003). If they match, then the system 801 finds records in the auto_number_component table 405 with the auto number id to obtain the auto numbering field's configuration for its components. These records contain their respective auto_number_component id's. Records in the auto_number_word_token table 406 with the auto_number_component_id specify the separators to be used for tokenizing an alpha-numeric source field. Records in the auto_number_component_word table 407 with the auto_number_component_id specify what to do with words taken from a source to build a component. The auto numbering field value is then generated accordingly (step 6004).

For each auto_number_id, the system 801 finds the record in the auto_number table 403 with the auto_number_id. This record contains the data field id of the data field in the PR record for which the auto numbering configuration applies. The data field is defined in the data_fields table 410. The system 801 stores the generated auto numbering field value in this data field (step 6005).

Once stored, a record is added to the auto_number_change_history table 408 for the change in the PR. The value for the auto number field is also stored in the auto_number_max table 409.

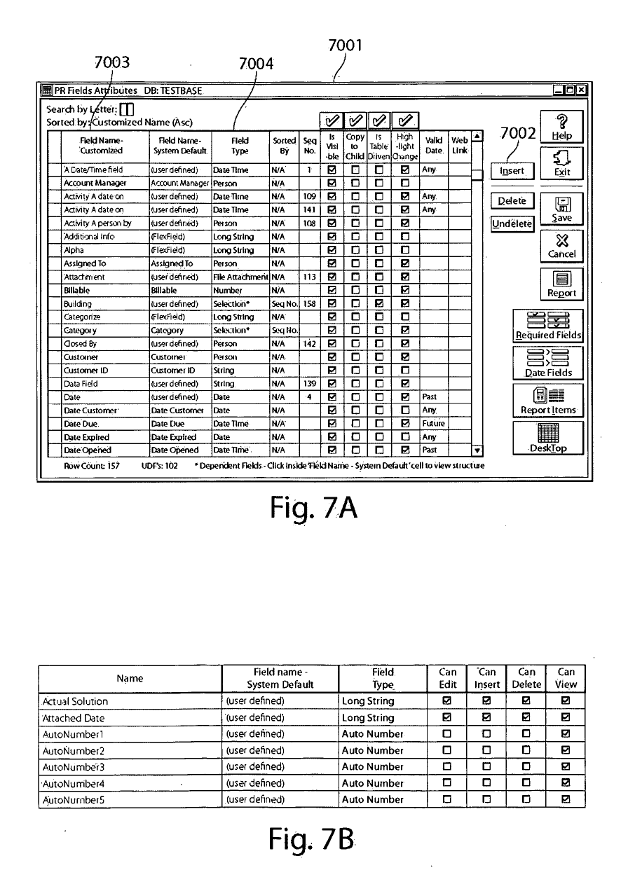

GUI's for Configuring Auto Numbering User-Defined Fields: FIGS. 7A-15

As pointed out in the foregoing, system 801 is highly configurable but limits the configurability so that it can be safely done by non-technical users of system 801. One reason for this combination of configurability and safety is the fact that database tables are used to determine the behavior of system 801. Consequently, the database system's tools can be used to configure the system, while the database system's access controls can be used to limit the degrees of configurability permitted to different users of the system. Another reason for the combination of configurability and safety in system 801 is the GUI which non-technical users of the system use to define and modify auto numbering user-defined fields. This GUI is disclosed in the following.

A window 7001 of the GUI for configuring auto numbering fields in a presently-preferred embodiment is shown FIG. 7A. To configure an auto number, first an auto number name is defined. A user selects the Insert button 7002, enters the name of the auto number in the “Field Name—Customized” column 7003, and selects “Auto Number” from a drop down list (not shown) in the Field Type column 7004. After defining the new data field, permissions are assigned for the new fields, as shown in FIG. 7B. Possible permissions include “can edit”, “can insert”, “can delete”, and “can view”.

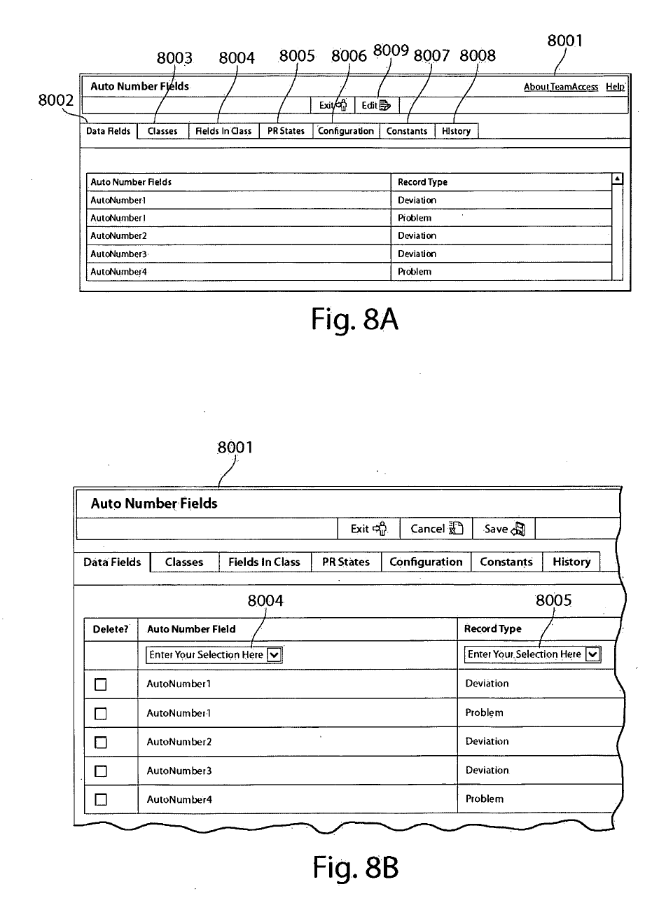

At any time during the running of a process, the auto numbers can be managed by selecting an “Auto Numbering” option in an administrative menu (not shown). An Auto Number Fields window 8001 is displayed, as shown in FIG. 8A. This window has six tabs: Data Fields 8002, Classes 8003, Fields in Class 8004, PR States 8005, Configuration 8006, and History 8007.

The Data Fields tab 8002 is selected to associate auto number fields to specific record types. A user selects the Edit button 8009 to enter into edit mode, shown in FIG. 8B. The user enters the auto number field 8004 and the record type 8005. This information is stored in the auto_number table 403, in the data_field_id and record type columns. These steps are repeated for each auto number data field to be edited.

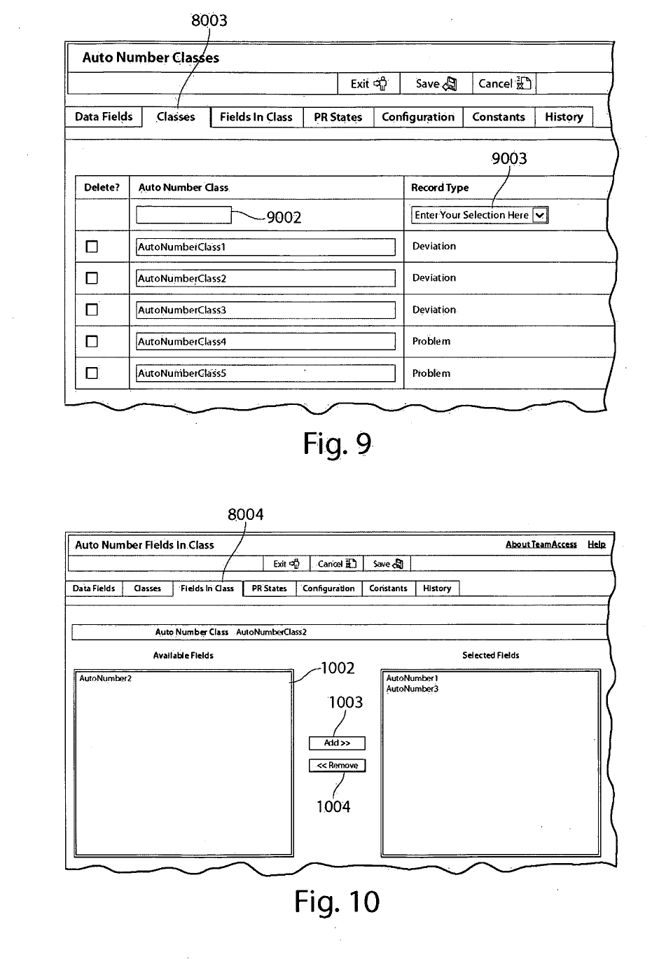

The Classes tab 8003 is selected to associate an auto number class to a specific record type. A user selects the Edit button (not shown) to enter into edit mode, shown in FIG. 9. The user enters an auto number class 9002 and the record type 9003. This information is stored in the auto_number_class table 401 in the name and record_type columns. These steps are repeated for each auto number class to be edited.

The Fields In Class tab 8004 is selected to associate an auto number field to a specific class. A user selects the Edit button (not shown) to enter into edit mode, shown in FIG. 10. The user selects an available field 1002 and selected the Add button 1003 to add the field, and selects the Remove button 1004 to remove the field, from the auto number class. This information is stored in the auto_number_class_details table 402 in the auto_number_class_id and auto_number_id columns. These steps are repeated for each auto number to be edited.

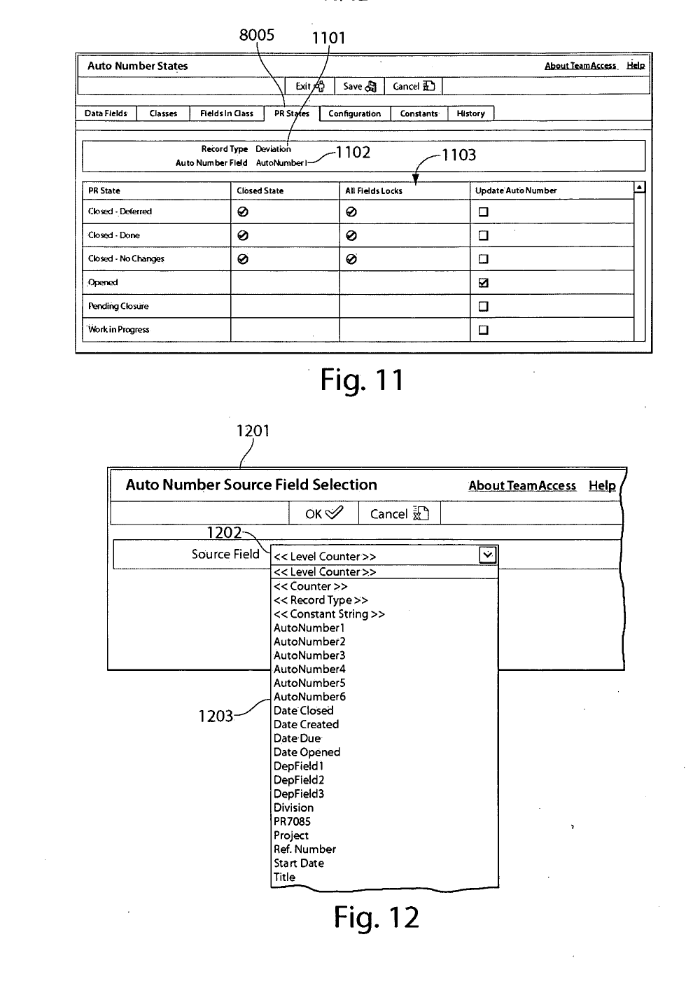

The PR States tab 8005 is selected to associate an auto number field to a specific PR state. A user first selects a record type 1101 and an auto number field 1102, then selects the Edit button (not shown) to enter into edit mode, shown in FIG. 11. The user checks the states 1003 where the auto number field is to be populated. This information is stored in the auto_number_on_pr_status table 404. These steps are repeated for each auto number to be edited.

The Configuration tab 8006 is selected to configure the fields that comprise each auto number field. A user selects a record type and an auto number field, then selects the Edit button (not shown) to enter into edit mode. The user then selects the Insert new component button (not shown). An Auto Number Source Field Selection window 1201 is displayed, as shown in FIG. 12. The user selects the Source Field 1202 from the available list of fields 1203. Once the source field is selected, its configuration of the source field depends upon the field type, as explained above.

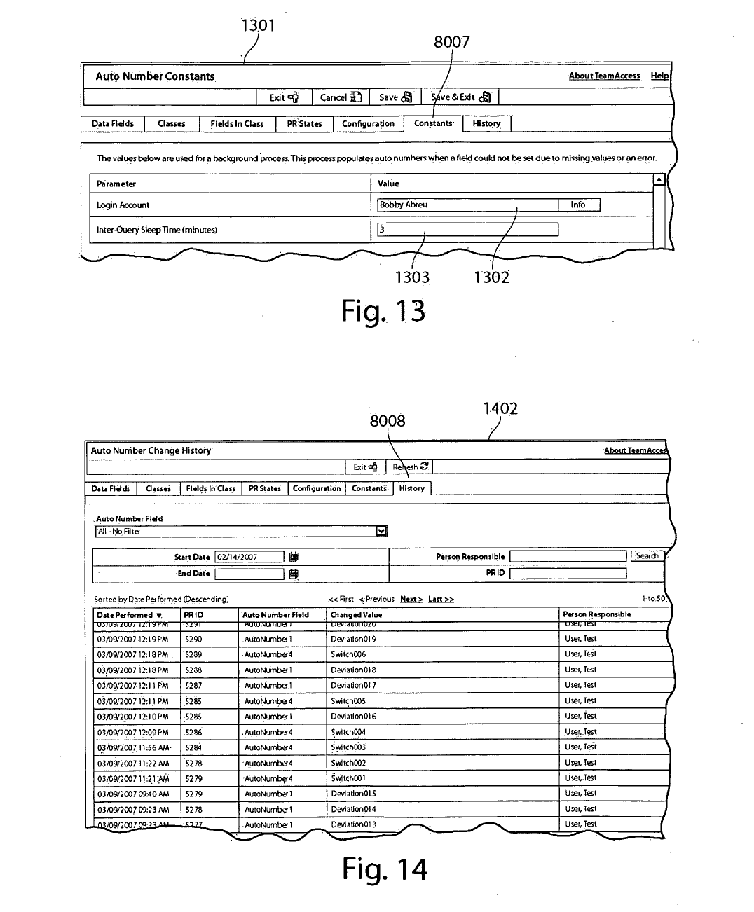

The Constants tab 8007 is selected to configure the auto number background process. The window 1301 for the Constants tab 8007 is shown in FIG. 13. This tab 8007 is used to systematically populate an auto number field if the system 801 prevents the auto number value from being saved, or when the auto number value cannot be set because values in required components are blank. Two parameters are used for the background process: Login Account and Inter-Query Sleep Time. For the Login Account, a name is entered in field 1302. This name will be displayed in the PR history as the user that set the value for the auto number field, if it was set systematically instead of by user action. For the Inter-Query Sleep Time, a time in minutes is entered in field 1303. This time is how frequent this process executes.

The History tab 8008 is selected to view configuration changes made to auto number fields. The History screen 1402, shown in FIG. 14, allows a user to view when the auto number field was populated. This screen also provides the ability to filter individual auto number fields, and to view the history based on data ranges, the person responsible, or the PR ID. The information for this screen is from the auto_number_change_history table 408.

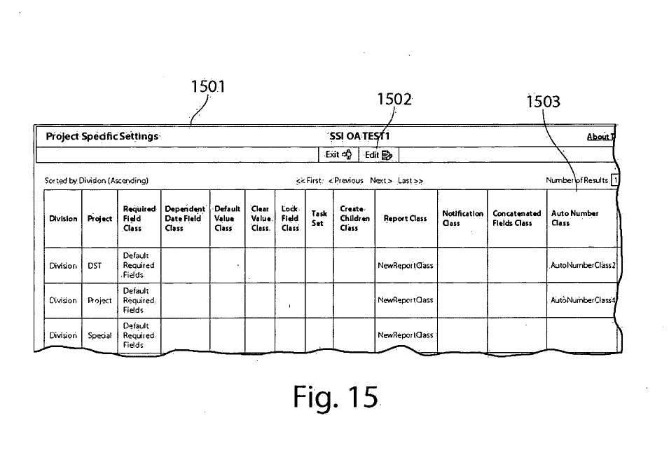

To assign an auto number class to a project, a “Project Specific Settings” option is selected from an admin menu (not shown). The Project Specific Settings screen 1501 is then displayed, shown in FIG. 15. The Edit button 1502 is selected to enter into edit mode. In the edit mode, the user locates the Division and Project for which to assign the auto number class. In the Auto Number Class field 1503, the class to assign to the selected project can be selected through a drop down list (not shown).

### CONCLUSION

The foregoing Detailed Description has disclosed to those skilled in the relevant arts how to make and use a process control system that automatically provides as much monitoring as is desirable for the processes being controlled and has disclosed to those skilled in the relevant arts the best mode presently known by the inventors for implementing their process control system. The information needed to do the monitoring, including the queries that perform the monitoring and the activities to be performed in response to conditions detected by the queries, is all contained in tables in a database system. The fact that the information is contained in the database tables makes the process control system easily and safely configurable and extendable. The ease and safety of configurability is further enhanced by the graphical user interface disclosed herein.

It will be immediately apparent to those skilled in the relevant arts that there are many other ways of implementing the process control system. In particular, there are many ways in which the information needed to do the monitoring can be represented in the database system. Moreover, the information needed and the manner in which the process control system operates will both vary with the kind of process being monitored; in the preferred embodiment, the processes being monitored are business processes; other embodiments may monitor physical processes and the information in the database system, the manner in which it is organized, and the manner in which it is used to do the monitoring will all vary accordingly.

The same is the case with regard to the graphical user interface. There are many ways in which graphical user interfaces that embody the principles of the inventions claimed herein can be implemented; How they look and work in detail will depend not only on the purpose for which the process control system is being used but also on the underlying graphical user interface tools and primitives provided by the system upon which the graphical user interface is implemented. Moreover, there are many other ways in which the principles of the inventions disclosed herein can be employed. Detailed operations and the details of how they are specified will of course also depend on the kinds of values which the field being acted on may have.

Similarly, there are many ways in which the techniques disclosed herein for operating on auto numbering user-defined fields in the process record can be implemented. The database scheme for auto numbering user-defined fields need not be implemented as they are in the preferred embodiment.

Since that is the case, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

We claim:

1. A process control system, comprising:
a server that has access to a database system and executes program code for the process control system;
a table of process records in the database system, a process record indicating a current condition of a process being controlled by the system and certain ones of the process records including one or more auto numbering user-defined fields; and
a portion of the program code which is executed when a process record enters a pre-defined state, whereby an auto numbering field value is generated according to a configuration of the auto numbering user-defined field and storing the generated auto number field value in the auto numbering user-defined field in the process record.

2. The system of claim 1, further comprising:
a table of auto numbering user-defined fields, comprising a record for each auto numbering user-defined field for a record type of the process record.

3. The system of claim 2, further comprising:
a table of auto numbering classes, comprising a record for each auto numbering class, wherein one of the auto numbering classes is associated with the record type of the process record; and
a table of auto numbering class details, comprising a record for each auto numbering user-defined field associated with a given auto numbering class.

4. The system of claim 2, further comprising:
a table of auto numbering PR status, comprising a record for each pre-defined process record state in which a given auto numbering user-defined field is to be generated.

5. The system of claim 2, further comprising:
a table of auto numbering components, comprising a record for each component to be used for generating or updating an auto numbering user-defined field.

6. The system of claim 5, wherein columns in each record of the auto numbering components table comprises settings for:
a source field;
a date format;
a prefix or suffix;
a counter; and
how characters from the source field will be used in a concatenation of results from each source field for a given auto numbering user-defined field.

7. The system of claim 5, further comprising:
a table of auto numbering word tokens, comprising a record for each separator to be used for tokenizing an alpha numeric source field.

8. The system of claim 5, further comprising:
a table of auto numbering component words for specifying what to do with words taken from a source field to build a component, comprising a record for each specification for a component.

9. A process control system, comprising:
a server that has access to a database system and executes program code for the process control system;
a table of process records in the database system, a process record indicating a current condition of a process being controlled by the system and certain ones of the process records including one or more auto numbering user-defined fields;
a table of auto numbering user-defined fields in the database system, comprising a record for each of the auto numbering user-defined fields;
a table of auto numbering process record status in the database system, comprising a record for each pre-defined process record state in which each auto numbering user-defined fields is to be generated; and
a portion of the program code which is executed when a process record enters the pre-defined state for an auto numbering user-defined field, whereby an auto numbering field value is generated according to a configuration of the auto numbering user-defined field and storing the generated auto numbering field value in the auto number user-defined field in the process record.

10. The system of claim 9, further comprising:
a table of auto numbering classes, comprising a record for each auto numbering class, wherein one of the auto numbering classes is associated with a record type of the process record; and
a table of auto numbering class details, comprising a record for each auto numbering user-defined field associated with a given auto numbering class.

11. The system of claim 9, further comprising:
a table of auto numbering components, comprising a record for each component to be used for generating or updating the auto numbering user-defined field.

12. The system of claim 11, wherein columns in each record of the auto numbering components table comprises settings for:
a source field;
a date format;
a prefix or suffix;
a counter; and
how characters from the source field will be used in a concatenation of results from each source field for the auto numbering user-defined field.

13. The system of claim 11, further comprising:
a table of auto numbering word tokens, comprising a record for each separator to be used for tokenizing an alpha numeric source field.

14. The system of claim 11, further comprising:
a table of auto numbering component words for specifying what to do with words taken from a source field to build a component, comprising a record for each specification for a component.
